(19) United States
(12) Patent Application Publication
(10) Pub. No.: US 2025/0189798 A1
(43) Pub. Date: Jun. 12, 2025

(54) LIGHT GUIDE PLATE LAMINATE, DISPLAY DEVICE, AND MODULE FOR DISPLAY DEVICE

(71) Applicant: SONY GROUP CORPORATION, Tokyo (JP)

(72) Inventor: Hidehiko TAKANASHI, Tokyo (JP)

(73) Assignee: SONY GROUP CORPORATION, Tokyo (JP)

(21) Appl. No.: 18/843,891

(22) PCT Filed: Mar. 13, 2023
(86) PCT No.: PCT/JP2023/009573

§ 371 Date: Sep. 4, 2024

(30) Foreign Application Priority Data
Mar. 23, 2022 (JP) 2022-046590

(51) Int. Cl. G02B 27/01

(52) U.S. Cl. CPC G02B 27/0172; G02B 2027/0114

(57) ABSTRACT

An object of the present disclosure is to provide a technique for keeping a uniform gap between a plurality of stacked light guide plates. The present disclosure provides a light guide plate laminate including at least a pair of light guide plates, the two light guide plates being stacked, in which a space between the two light guide plates is in a state of reduced pressure. The space may have a pressure of 90 kPa or less. The space may be enclosed. The present disclosure also provides a display device and a module for the display device, the display device and the module for the display device being provided with a light guide plate laminate including at least a pair of light guide plates, the two light guide plates being stacked, in which a space between the two light guide plates is in a state of reduced pressure.

### TECHNICAL FIELD

The present disclosure relates to a light guide plate laminate, a display device, and a module for the display device.

### BACKGROUND ART

A head-mounted display (also called an HMID) is a kind of device for displaying video. HMDs have been used in various phases. Some HMDs use a technique of displaying an image superimposed on an external scene. Such a technique is also called an augmented reality (also called AR) technique. An AR glass is an example of a product using the technique.

Various proposals have been made for an augmented reality technique. For example, PTL 1 below discloses an optical system for augmented reality. The optical system includes a set of separate waveguides to be stacked. At least one of the waveguides includes an optical transmission core layer that has a principal surface on a side opposite to the other principal surface and an auxiliary layer that is an optical transmission auxiliary layer on the principal surface and has a nanophotonic structure. The auxiliary layer has a smaller thickness than the core layer and is made of a material different from that of the core layer (claim 13).

### CITATION LIST

### Patent Literature

PTL 1: Japanese Translation of PCT Application No. 2021-519445

### SUMMARY

### Technical Problem

A light guide plate may be used as an optical element for transmitting video display light, which is generated by the rendering system of an HMD, to user's eyes. Furthermore, in order to present full-color video to a user, a plurality of stacked light guide plates may be used as a potential technique.

However, when multiple light guide plates are stacked, a gap between the light guide plates is desirably kept uniform in order to prevent, for example, a color shift or a decrease in resolution.

An object of the present disclosure is to provide a technique for keeping a uniform gap between stacked light guide plates.

### Solution to Problem

The present disclosure provides a light guide plate laminate including
at least a pair of light guide plates, the two light guide plates being stacked,
wherein a space between the two light guide plates is in a state of reduced pressure.

The space may have a pressure of 90 kPa or less.

The space may be enclosed.

The two light guide plates may be stacked with an adhesive interposed therebetween.

The adhesive may include a spacer,

The light guide plate laminate may include one or more gas barrier layers stacked on each of the light guide plates.

The one or more gas barrier layers may be joined to an adhesive, and the space may be formed by the one or more gas barrier layers and the adhesive.

The light guide plate laminate may include an entrance portion that passes light into each of the light guide plates and an exit portion that emits light from each of the light guide plates.

The space in the state of reduced pressure may cover one or both of the entrance portion and the exit portion.

The entrance portion, the exit portion, or both of the entrance portion and the exit portion may include diffraction gratings provided on each of the light guide plates.

The light guide plate laminate may include a pressure-reducing port sealed with a sealer.

The light guide plate laminate may include three or more stacked light guide plates, and a space between two of the three or more light guide plates may be placed in a state of reduced pressure.

The light guide plate laminate may include a pressure-reducing region between the two light guide plates.

The light guide plate laminate may include two or more pressure-reducing regions between the two light guide plates.

Each of the light guide plates included in the light guide plate laminate may be provided with two diffraction gratings.

Each of the light guide plates included in the light guide plate laminate may be provided with three or more diffraction gratings.

The present disclosure also provides a display device including a light guide plate laminate including at least a pair of light guide plates, the two light guide plates being stacked, wherein a space between the two light guide plates is in a state of reduced pressure.

The present disclosure also provides a module for a display device including a light guide plate laminate including
at least a pair of light guide plates, the two light guide plates being stacked,
wherein a space between the two light guide plates is in a state of reduced pressure.

### BRIEF DESCRIPTION OF DRAWINGS

FIG. 1A is a schematic diagram illustrating a configuration example of a light guide plate laminate according to the present disclosure.

FIG. 1B is an explanatory drawing illustrating the traveling direction of light in the light guide plate laminate according to the present disclosure.

FIG. 1C is an explanatory drawing showing the dimensions of the light guide plate laminate according to the present disclosure.

FIG. 2 is a flowchart showing an example of a method for manufacturing the light guide plate laminate according to the present disclosure.

FIG. 3 is a schematic diagram illustrating a configuration example of a light guide plate laminate according to the present disclosure.

FIG. 4 is a flowchart showing an example of a method for manufacturing the light guide plate laminate according to the present disclosure.

FIG. 5 is a schematic diagram illustrating a configuration example of a light guide plate laminate according to the present disclosure.

FIG. 6 is an explanatory drawing illustrating the traveling direction of light in the light guide plate laminate according to the present disclosure.

FIG. 7 is an explanatory drawing illustrating a layout example of an adhesive.

FIG. 8 illustrates an example of diffraction gratings provided on a light guide plate.

FIG. 9 illustrates an example of diffraction gratings provided on a light guide plate.

FIG. 10 is a schematic diagram illustrating a configuration example of a light guide plate laminate according to the present disclosure.

FIG. 11 is a schematic diagram illustrating a configuration example of a display device according to the present disclosure.

FIG. 12 is a schematic diagram illustrating a configuration example of a light guide plate laminate according to the present disclosure.

### DESCRIPTION OF EMBODIMENTS

Preferred embodiments for implementing the present disclosure will be described below.

Embodiments described below show typical embodiments of the present disclosure, and the scope of the present disclosure is not limited to these embodiments.

The embodiments of the present disclosure will be described in the following order.
1. Description of present disclosure
2. First embodiment (light guide plate laminate)
(1) Configuration example 1
(2) Manufacturing method
(3) Configuration example 2
(4) Manufacturing method
(5) Modification example (light guide plate laminate including three or more light guide plates)
(6) Modification example (layout of pressure-reducing space)
(7) Modification example (layout of diffraction grating)
(8) Modification example (gas barrier layer)
(9) Modification example (example of transmission diffraction)
3. Second embodiment (display device)
4. Third embodiment (module for display device)

### 1. Description of Present Disclosure

As described above, when multiple light guide plates are laminated or stacked, a gap between the light guide plates is desirably kept uniform. For example, if the gaps are not kept uniform, a color shift may occur between video display light beams guided by the respective light guide plates. Moreover, if the gaps are not kept uniform, video formed by video display light emitted from the multiple light guide plates may decrease in resolution. Thus, a gap between the light guide plates is desirably kept uniform in order to present advanced video.

Furthermore, the overall thickness of a light guide plate laminate is desirably reduced. For example, an HMD to be mounted on the head of a user desirably has a minimum weight. Accordingly, the overall thickness of the light guide plate laminate to be assembled to the HMD is desirably reduced to offer a weight reduction of the light guide plate laminate.

In order to reduce the overall thickness of the light guide plate laminate, each of the light guide plates may be reduced in thickness. However, a reduction in the thickness of the light guide plate is likely to cause warpage on the light guide plate. Such warpage is likely to occur specifically when the light guide plate is made of resin. Such warpage may cause difficulty in keeping a uniform gap between the light guide plates.

Moreover, spacers may be dispersed or formed in the surfaces of the stacked light guide plates in order to form uniform gaps between the light guide plates. However, warpage or torsion on the light guide plates may make it difficult to form uniform gaps. Furthermore, after being stacked, the light guide plates are released from a pressure for stacking the light guide plates, which may interfere with the formation of uniform gaps.

The present inventor found that a specific light guide plate laminate is useful for keeping a uniform gap between the light guide plates. Specifically, a light guide plate laminate according to the present disclosure includes at least a pair of light guide plates, the light guide plates being stacked, and a space between the two light guide plates is in a state of reduced pressure. The state of reduced pressure contributes to keeping a uniform gap between the stacked light guide plates.

For example, the light guide plate laminate according to the present disclosure may be manufactured by bonding multiple light guide plates in a vacuum. By bonding the light guide plates in a vacuum, a region surrounded by a sealing compound is set in a state of reduced pressure. Moreover, accurate gap uniformity can be achieved by the presence of the spacers between the light guide plates in addition to the state of reduced pressure. The dimensions of the gap can be determined by the size (thickness) of the spacer. Thus, the dimensions of the gap can be also controlled with a precision around sub m. In other words, the present disclosure can improve gap accuracy between the light guide plates.

Moreover, the state of reduced pressure provides the light guide plate laminate with stiffness. This can further prevent an external force from causing warpage on the light guide plates. In other words, the present disclosure can improve the mechanical reliability of the light guide plate laminate.

### 2. First Embodiment (Light Guide Plate Laminate)

### (1) Configuration Example 1

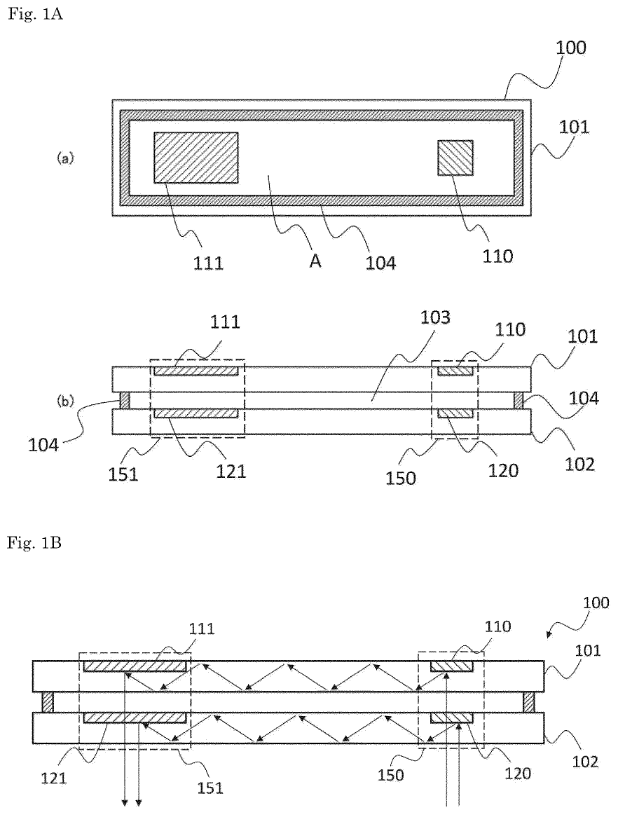

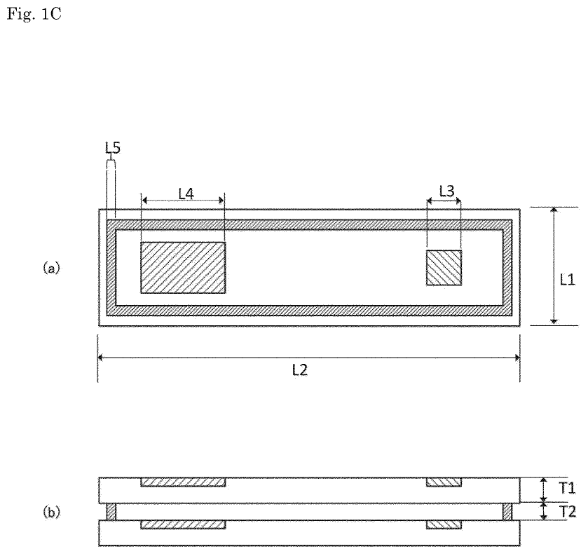

Referring to FIG. 1A, a configuration example of a light guide plate laminate according to the present disclosure will be described below. In the drawing, a schematic top view (a in the upper part of the drawing) and a schematic cross-sectional view (b in the lower part of the drawing) of the light guide plate laminate are illustrated. Alight guide plate laminate 100 illustrated in the drawing includes a pair of light guide plates 101 and 102. The light guide plates 101 and 102 are stacked with a space 103 provided therebetween. The space is in a state of reduced pressure. In order to form the space, the light guide plates 101 and 102 are bonded with an adhesive 104 including a spacer. In other words, the space 103 is enclosed with the adhesive 104 and the light guide plates 101 and 102. As described above, the space between the stacked light guide plates of the pair is in a state of reduced pressure, thereby keeping a uniform gap between the two light guide plates.

As described above, the space 103 is in a state of reduced pressure. A pressure in the space 103 may be lower than a pressure in an environment where the light guide plate laminate 100 is used.

The pressure may be adjusted to increase, for example, the stiffness of the light guide plates.

The pressure may be set at, for example, 95 kPa or lower, 90 kPa or lower, 85 kPa or lower, or 80 kPa or lower in consideration of a typical atmospheric pressure.

If the pressure is too low, the structure of the light guide plate or the light guide plate laminate may be adversely affected. Thus, the pressure may be, for example, 0 kPa or higher, 10 kPa or higher, 20 kPa or higher, or 30 kPa or higher.

The light guide plate laminate 100 includes an entrance portion 150 that passes video display light into each of the light guide plates and an exit portion 151 that emits video display light from each of the light guide plates.

The light guide plate 101 includes diffraction gratings 110 and 111. The light guide plate 102 includes diffraction gratings 120 and 121. From among these diffraction gratings, the diffraction gratings 110 and 120 are included in the entrance portion 150. The diffraction gratings 111 and 121 are included in the exit portion 151.

Referring to FIG. 1B, the control of traveling of video display light through the light guide plates and the diffraction gratings will be described below. FIG. 1B schematically illustrates the traveling directions of light in the lower drawing b of FIG. 1A.

The diffraction grating 110 may be provided at a position where video display light enters the light guide plate 101. The diffraction grating 110 may be configured to diffract (specifically reflect and diffract) video display light reaching the diffraction grating 110 and cause the video display light to travel in the light guide plate 101. The video display light travels to the diffraction grating 111 while totally reflecting in the light guide plate 101.

The diffraction grating for guiding video display light thus into the light guide plate is also referred to as an in-diffraction grating.

The diffraction grating 111 may be provided at a position where video display light is emitted from the light guide plate 101. The diffraction grating 111 may be configured to diffract (specifically reflect and diffract) video display light reaching the diffraction grating 111 and cause the video display light to travel out of the light guide plate 101.

The diffraction grating for emitting video display light thus out of the light guide plate is also referred to as an out-diffraction grating.

The diffraction grating 120 may be provided at a position where video display light enters the light guide plate 102. The diffraction grating 120 may be configured to diffract (specifically reflect and diffract) video display light reaching the diffraction grating 120 and cause the video display light to travel out of the light guide plate 102.

The diffraction grating 121 may be provided at a position where video display light is emitted from the light guide plate 102. The diffraction grating 121 may be configured to diffract (specifically reflect and diffract) video display light reaching the diffraction grating 121 and cause the video display light to travel out of the light guide plate 102.

As illustrated in the top view of FIG. 1A, the diffraction gratings 110 and 111 may be provided in a region A defined by the adhesive 104. The diffraction gratings 120 and 121 may also be provided in the region A defined by the adhesive 104. In other words, the entrance portion and the exit portion are covered with the space 103.

As described above, the diffraction gratings for emitting video display light into and out of the light guide plate are present in a pressure-reducing space (in a region surrounded by the adhesive that defines the pressure-reducing space), which contributes to improvement in image quality. This can achieve, for example, an improvement in resolution or prevention of a color shift.

The light guide plate laminate 100 may be configured such that video display light with different wavelengths or wave ranges is guided in the light guide plates 101 and 102.

For such a configuration, for example, the diffraction grating 120 may be configured to reflect and diffract light to travel with a wavelength or a wave range in the light guide plate 102 and transmit light to travel with a wavelength of a wave range in the light guide plate 101. The diffraction grating 110 may be configured to reflect and diffract light to travel with a wavelength or a wave range in the light guide plate 101. The optical properties (specifically diffraction properties) of the diffraction gratings 120 and 110 are adjusted thus, thereby controlling light traveling in the light guide plates.

The diffraction grating 111 may be configured to reflect and diffract light that has traveled in the light guide plate 101 and reached the diffraction grating 111. The diffraction grating 121 may be configured to transmit light that has been reflected and diffracted by the diffraction grating 111 and emitted out of the light guide plate 101 and reflect and diffract light that has traveled in the light guide plate 102 and reached the diffraction grating 121. The optical properties (specifically diffraction properties) of the diffraction gratings 111 and 121 are adjusted thus, so that the light beams having traveled in the light guide plates are multiplexed and projected to the eyes of a user.

The material of the light guide plates 101 and 102 may be a resin material or a glass material. A resin material is preferable. The resin material may be, for example, a polycarbonate resin, a polymethyl methacrylate resin, or a cycloolefin resin and is not limited thereto.

The material preferably provides an excellent gas barrier property. Accordingly, a state of reduced pressure can be properly kept. For the gas barrier property, the light guide plates may have a moisture-vapor transmission and/or an air component transmission as will be described later. The air component transmission may be a transmission of a principal component contained in air and may be, for example, an oxygen transmission or a nitrogen transmission.

The material is preferably transparent. Thus, for example, if the light guide plate laminate is placed in front of eyes, the light guide plate laminate allows video display light to reach the eyes while transmitting an external scene to the eyes. Thus, AR video can be presented to a user.

Referring to FIG. 1C, an example of the dimensions of the light guide plates 101 and 102 will be described below.

If the light guide plates are rectangular, a length L1 of a short side of the rectangle may be, for example, 10 mm or more or specifically 20 mm or more. The length L1 may be, for example, 120 mm or less or specifically 100 mm or less.

A length L2 of a long side of the rectangle may be, for example, 30 mm or more or specifically 50 mm or more. The length L2 may be, for example, 120 mm or less or specifically 100 mm or less.

Needless to say, the shape of the light guide plate is not limited to the rectangle of the drawing. For example, the light guide plate may be shaped like a rectangle with rounded corners or a spectacle lens.

The dimensions of the shape of the light guide plate may be set as appropriate by a person skilled in the art according to the size and number of diffraction gratings provided on the light guide plate or factors such as a light guide direction.

A thickness T1 of the light guide plate may be, for example, 0.1 mm or more or specifically 0.3 mm or more. The thickness T1 may be, for example, 2.0 mm or less or specifically 1.5 mm or less.

The thickness of the light guide plate may be set as appropriate by a person skilled in the art according to factors such as the material of the light guide plate.

A thickness T2 (also referred to as a gap thickness) between the light guide plates in a pair may be, for example, 0.05 mm or more or specifically 0.1 mm or more. The thickness T2 may be, for example, 1.5 mm or less or specifically 1.0 mm or less.

The gap thickness may be set as appropriate by a person skilled in the art according to, for example, factors such as the kind of adhesive material and the kind of spacer to be included in the adhesive.

The light guide plates 101 and 102 may be stacked with the adhesive 104 interposed therebetween. The adhesive 104 preferably includes a spacer (not illustrated). The spacer allows more accurate control on a distance between the light guide plate 101 and the light guide plate 102.

Among the diffraction gratings provided for the light guide plates, the dimensions of the in-diffraction gratings (diffraction gratings 110 and 120) may include a length L3 of, for example, 1 mm or more or specifically 2 mm or more on one side if the diffraction gratings are rectangular. The one side may be, for example, 20 mm or less or specifically 15 mm or less.

The dimensions of the in-diffraction gratings may be selected as appropriate by a person skilled in the art depending upon, for example, a rendering system for forming video display light and a light guide optical system for guiding video display light to the light guide plate laminate. Among the diffraction gratings provided for the light guide plates, the dimensions of the out-diffraction gratings (diffraction gratings 111 and 121) may include a length L4 of, for example, 5 mm or more or specifically 10 mm or more on one side if the diffraction gratings are rectangular. The length L4 of the one side may be, for example, 30 mm or less or specifically 25 mm or less. The dimensions of the out-diffraction gratings may be selected as appropriate by a person skilled in the art according to, for example, the size of a field of view.

These diffraction gratings may be provided in the light guide plates according to a known method of the technical field. A person skilled in the art can manufacture desired diffraction gratings as appropriate.

A width L5 of the adhesive may be, for example, 0.05 mm or more or specifically 0.1 mm or more. The width L5 may be, for example, 1.5 mm or less or specifically 1 mm or less.

The adhesive may be an acrylic adhesive, an epoxy adhesive, a urethane adhesive, or an olefin adhesive and is not limited thereto. The adhesive preferably provides an excellent gas barrier property for a hardened material. The adhesive may be a photo-curable adhesive or a thermosetting adhesive. The adhesive is preferably a photo-curable adhesive and may be specifically an ultraviolet curing adhesive.

The spacer is, for example, particles and may be specifically organic particles or inorganic particles. The particles are preferably particles having a substantially equal particle diameter. The particle diameters of the particles may be set as appropriate by a person skilled in the art according to, for example, the above-mentioned gap thickness.

The spacer is preferably made of, for example, a polymerizable resin. Examples of the polymerizable resin include OPTMER NN Series from JSR Corporation, a resist for a photo spacer from OSAKA ORGANIC CHEMICAL INDUSTRY LTD., TPSR series from TOKYO OHKA KOGYO CO., LTD., and PHOTOCLEAR from Toray Industries, Inc. Specifically, the spacer may be a photo spacer or a permanent resist. Examples of the photo spacer include a photo spacer used for an LCD. Examples of the permanent resist include a permanent resist used for a MEMS. These spacers have quite high in-plane uniformity in thickness, thereby forming highly accurate gaps between the light guide plates. Moreover, the spacers such as the photo spacer and the permanent resist can be generated by forming a resist in a desired shape with a desired size at a desired position according to photolithography, so that the spacers can be laid out without affecting the optical properties of the light guide plates.

The organic particles may be, for example, polymer particles and specifically acrylic polymer particles, urethane polymer particles, polycarbonate particles, olefin particles, or epoxy polymer particles.

The inorganic particles may be particles composed primarily of silica, alumina, zirconium oxide, magnesium oxide, calcium carbonate, magnesium carbonate, barium sulfate, talc, or montmorillonite, or may be preferably particles composed primarily of silica or alumina.

### (2) Manufacturing Method

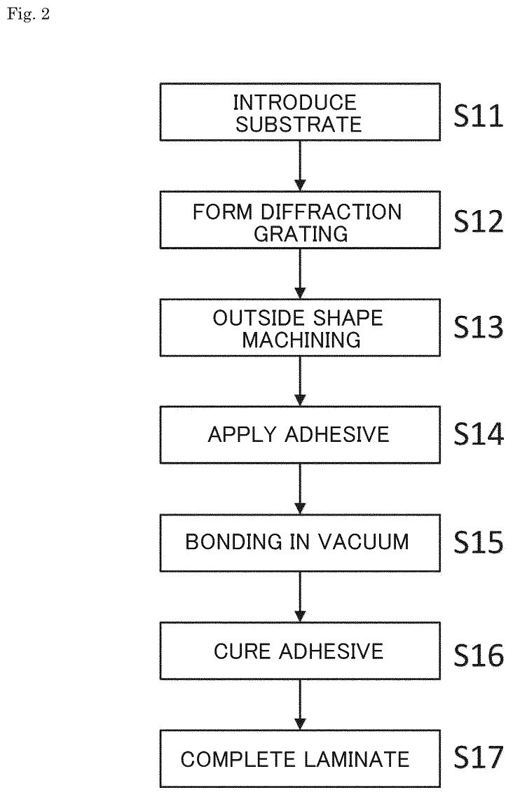

Referring to FIG. 2, a method for manufacturing the light guide plate laminate illustrated in (1) will be described below. FIG. 2 is a flowchart showing an example the manufacturing method.

As shown in FIG. 2, substrates for forming the light guide plates 101 and 102 are prepared in step S11. The substrates may be made of a material usable as a light guide plate and may be selected as appropriate by a person skilled in the art. The substrates may be made of, for example, resin or glass and is specifically made of resin. The resin may be, for example, a polycarbonate resin or a polymethyl methacrylate resin.

In step S12, the diffraction gratings 110 and 111 and the diffraction gratings 120 and 121 are formed in the substrates. A known method of the technical field may be used to form these diffraction gratings. The method may be, for example, a nanoimprint method, an injection molding method, a casting method, or hologram exposure and is not limited thereto. A person skilled in the art can produce diffraction gratings with desired diffraction properties as appropriate.

In step S13, the substrate with the formed diffraction gratings is machined into a desired shape. For example, the substrate may be cut to a size or shape suitable as a light guide plate for eyewear. For the machining, lasing, stamping, or cutting may be performed. The machining is performed such that a portion where the diffraction grating is formed is included in the light guide plate. Through the machining, the light guide plates 101 and 102 including the diffraction gratings are obtained.

In step S14, the adhesive 104 (specifically an adhesive including a spacer) is applied to the light guide plate 101 or 102. As illustrated in FIG. 1A, the adhesive 104 is applied around the diffraction gratings such that a closed space is formed by the light guide plate 101, the light guide plate 102, and the adhesive 104. A method for the application may be selected as appropriate by a person skilled in the art and may be, for example, a print process or a dispensing method.

In step S15, the light guide plate 101 is bonded to the light guide plate 102 with the adhesive 104 interposed therebetween. The bonding is performed in a vacuum condition. The vacuum condition may be a pressure lower than an atmospheric pressure and may be adjusted as appropriate by a person skilled in the art according to a state of reduced pressure required for the space 103. As described above, the two light guide plates are stacked in the vacuum condition, thereby placing the space between the two light guide plates into a state of reduced pressure.

In step S16, the adhesive 104 is cured. A curing method may be selected as appropriate by a person skilled in the art depending upon the kind of adhesive. The curing method may be, for example, photoirradiation (specifically ultraviolet irradiation) or heating.

In step S17, the completed light guide plate laminate 100 is obtained. Moreover, a protective layer for protecting the surface of the light guide plate may be formed on the surface of the light guide plate of the light guide plate laminate. The protective layer may be performed in any other steps or between any two of the steps.

The present disclosure also provides a method for manufacturing the light guide plate laminate according to the present disclosure. As described above with reference to FIG. 2, the manufacturing method may include stacking two light guide plates in a vacuum condition. The two light guide plates may be stacked with an adhesive interposed therebetween. The adhesive may be cured after the stacking.

### (3) Configuration Example 2

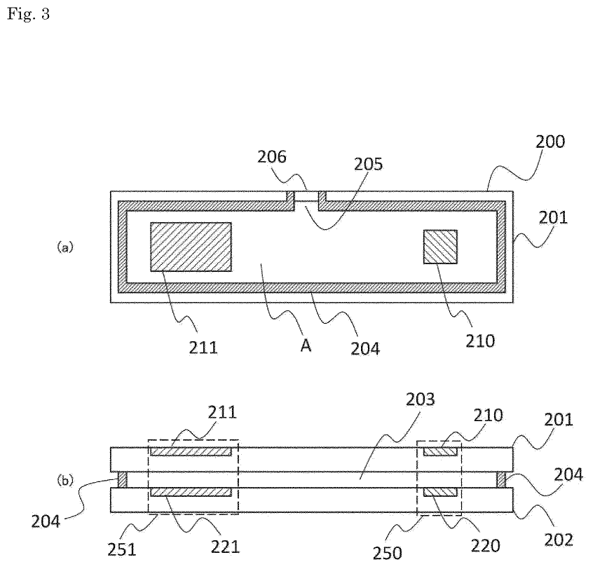

A state of reduced pressure in the light guide plate laminate 100 described in (1) is obtained by bonding the multiple light guide plates in a vacuum condition as described in (2). The light guide plate laminate according to the present disclosure may be manufactured by reducing a pressure in the space between the light guide plates in a pair. Referring to FIG. 3, a configuration example of the light guide plate laminate manufactured thus will be described below.

In the drawing, a schematic top view (the upper part of the drawing) and a schematic cross-sectional view (the lower part of the drawing) of the light guide plate laminate are illustrated. A light guide plate laminate 200 illustrated in the drawing includes a pair of light guide plates 201 and 202. The light guide plates 201 and 202 are stacked with a space 203 provided therebetween. The space is in a state of reduced pressure. In order to form the space, the light guide plates 201 and 202 are bonded with an adhesive 204 including a spacer.

As illustrated in FIG. 3, the adhesive 204 is provided to form a pressure-reducing port 205. As will be described later, the pressure-reducing port is used to place the space between the light guide plates of the pair into a state of reduced pressure.

Moreover, the pressure-reducing port is sealed with a sealer 206 after a pressure is reduced. The sealer may be identical to the adhesive 204 or a different adhesive. In other words, the light guide plate laminate 200 has the pressure-reducing port sealed with the sealer 206.

Thus, the space 203 is enclosed with the adhesive 204, the sealer 206 for sealing the pressure-reducing port 205, and the light guide plates 201 and 202. As described above, the space between the stacked light guide plates in the pair is in a state of reduced pressure, thereby keeping a uniform gap between the two light guide plates.

As described above, the space 203 is in a state of reduced pressure. A pressure in the space 203 may be lower than a pressure in an environment where the light guide plate laminate 200 is used.

The pressure may be adjusted to increase, for example, the stiffness of the light guide plates.

The pressure may be set at, for example, 95 kPa or lower, 90 kPa or lower, 85 kPa or lower, or 80 kPa or lower in consideration of a typical atmospheric pressure.

If the pressure is too low, the structure of the light guide plate or the light guide plate laminate may be adversely affected. Thus, the pressure may be, for example, 30 kPa or higher, 40 kPa or higher, or 50 kPa or higher.

The light guide plate laminate 200 includes an entrance portion 250 that passes video display light into the light guide plates and an exit portion 251 that emits video display light from the light guide plates.

The light guide plate 201 includes diffraction gratings 210 and 211. The light guide plate 202 includes diffraction gratings 220 and 221. From among these diffraction gratings, the diffraction gratings 210 and 220 are included in the entrance portion 250. The diffraction gratings 211 and 221 are included in the exit portion 251.

The diffraction gratings 210 and 211 and the diffraction gratings 220 and 221 may have optical properties (specifically diffraction properties) similar to those of the diffraction gratings 110 and 111 and the diffraction gratings 120 and 121 that are described in (1). In other words, video display light may travel as described in (1).

As illustrated in the top view of FIG. 3, the diffraction gratings 210 and 211 may be provided in a region A defined by the adhesive 204 and the sealer 206. The diffraction gratings 220 and 221 may also be provided in the region A defined by the adhesive 204 and the sealer 206. As described above, the diffraction gratings for emitting video display light into and out of the light guide plate are present in a pressure-reducing space (in a region surrounded by the adhesive that defines the pressure-reducing space), which contributes to improvement in image quality. This can achieve, for example, an improvement in resolution or prevention of a color shift.

The description of the light guide plates 101 and 102 in (1) applies to the light guide plates 201 and 202.

The description of the adhesive 104 in (1) applies to the adhesive 204.

The sealer 206 may be identical to the adhesive 104 in (1), and the description of the adhesive 104 applies to the sealer 206.

### (4) Manufacturing Method

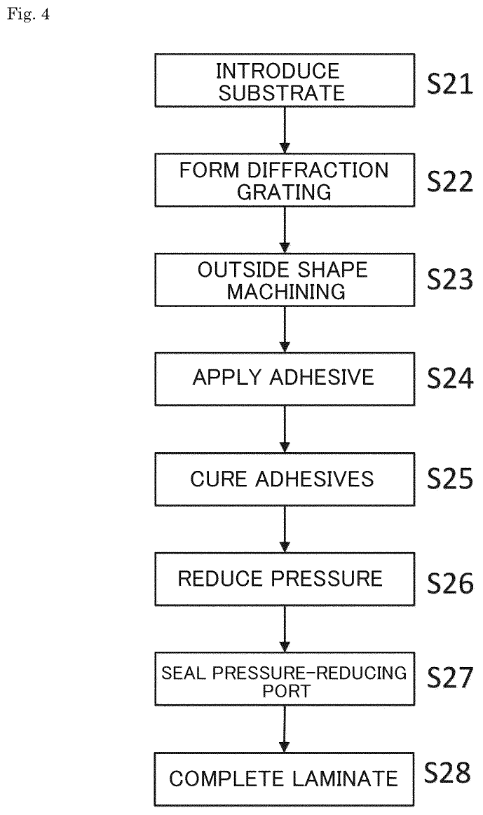

Referring to FIG. 4, a method for manufacturing the light guide plate laminate illustrated in (3) will be described below. FIG. 4 is a flowchart showing an example the manufacturing method.

As shown in FIG. 4, substrates for forming the light guide plates 201 and 202 are prepared in step S21. In step S22, the diffraction gratings 210 and 211 and the diffraction gratings 220 and 221 are formed in the substrates. In step S23, the substrate with the formed diffraction gratings is machined into a desired shape. Steps S21, S22, and S23 may be performed like steps S11, S12, and S13 described in (2).

In step S24, the adhesive 104 (specifically an adhesive including a spacer) is applied to the light guide plate 201 or 202. As illustrated in FIG. 3, the adhesive 204 is applied around the diffraction gratings such that the pressure-reducing port 205 is formed. A method for the application may be selected as appropriate by a person skilled in the art and may be, for example, a print process or a dispensing method. The enclosed space is formed by the sealer 206 that seals the pressure-reducing port 205 in the after-mentioned step, the light guide plates 201 and 202, and the adhesive 204.

In step S25, the light guide plate 201 is bonded to the light guide plate 202 with the adhesive 204, and then the adhesive 204 is cured. The bonding and the curing may be performed in an atmospheric pressure. A curing method may be selected as appropriate by a person skilled in the art depending upon the kind of adhesive. The curing method may be, for example, photoirradiation (specifically ultraviolet irradiation) or heating.

In step S26, a pressure is reduced to place a space between the light guide plate 201 and the light guide plate 202 into a state of reduced pressure. A method of the pressure reduction may be selected as appropriate by a person skilled in the art. For example, after the curing in step S205, the inside of the space 203 is placed in a state of reduced pressure by a pressure reducing device, e.g., a pump using the pressure-reducing port 205. The state of reduced pressure is kept until the pressure-reducing port is sealed in the subsequent step S27.

In step S27, the pressure-reducing port 205 is sealed with the sealer 206. As described above, the sealer may be identical to or different from the adhesive 204. The sealer is applied between the light guide plates 201 and 202 so as to close the pressure-reducing port 205. Thereafter, the sealer is cured by cure treatment, for example, photoirradiation.

In step S28, the completed light guide plate laminate 200 is obtained. Moreover, a protective layer for protecting the surface of the light guide plate may be formed on the surface of the light guide plate of the light guide plate laminate. The protective layer may be performed in any other steps or between any two of the steps.

The present disclosure also provides a method for manufacturing the light guide plate laminate according to the present disclosure. As described above with reference to FIG. 4, in the manufacturing method, the space between the two light guide plates may be placed in a state of reduced pressure by reducing a pressure through the pressure-reducing port after the two light guide plates are stacked.

The two light guide plates may be stacked with an adhesive interposed therebetween. Thea adhesive may be applied so as to form the pressure-reducing port. The adhesive may be cured after the stacking. Thus, the light guide plates are stacked with the pressure-reducing port.

### (5) Modification Example (Light Guide Plate Laminate Including Three or More Light Guide Plates)

The light guide plate laminates in the configuration examples described in (1) to (4) are each configured with two light guide plates. The number of light guide plates included in the light guide plate laminate according to the present disclosure is not limited to two. The number of light guide plates included in the light guide plate laminate according to the present disclosure may be two or more. The number of light guide plates may be any one of integer values ranging from, for example, 2 to 20 and specifically any one of integer values ranging from 2 to 10. According to an embodiment, the light guide plate laminate may include three or more stacked light guide plates and a space between two of the three or more light guide plates may be placed in a state of reduced pressure.

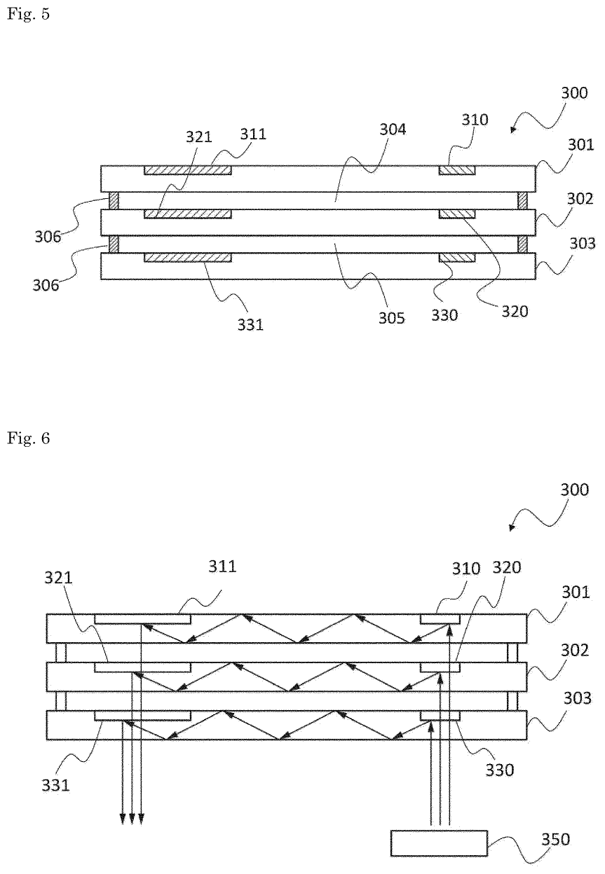

Referring to FIG. 5, the embodiment of the light guide plate laminate including the three light guide plates will be described below.

Alight guide plate laminate 300 illustrated in the drawing includes light guide plates 301, 302, and 303. A space 304 between the light guide plates 301 and 302 in a pair is in a state of reduced pressure. A space 305 between the light guide plates 302 and 303 in a pair is also in a state of reduced pressure. In this way, the spaces between the light guide plates in pairs may be in a state of reduced pressure.

In order to form the space 304, the light guide plates 301 and 302 are bonded with an adhesive 306 including a spacer. Moreover, in order to form the space 305, the light guide plates 302 and 303 are also bonded with the adhesive 306 including a spacer.

The light guide plate 301 includes diffraction gratings 310 and 311.

The light guide plate 302 includes diffraction gratings 320 and 321.

The light guide plate 303 includes diffraction gratings 330 and 331.

The light guide plate laminate 300 may be configured such that video display light with different wavelengths or wave ranges is guided in the light guide plates 301, 302, and 303. Referring to FIG. 6, the control of traveling of light in the light guide plate laminate 300 will be described below. FIG. 6 is a schematic explanatory drawing of the control.

The light guide plate laminate 300 is disposed at a position where video display light generated by a rendering system 350 arrives. The video display light is divided into, for example, light beams with three wavelengths or wave bands by the diffraction gratings 310, 320, and 330 as will be described below.

The diffraction grating 330 may be configured to reflect and diffract light to travel with a wavelength or a wave range in the light guide plate 303 and transmit light to travel with a wavelength of a wave range in the light guide plates 301 and 302.

The diffraction grating 320 may be configured to reflect and diffract light to travel with a wavelength or a wave range in the light guide plate 302 and transmit light to travel with a wavelength of a wave range in the light guide plate 301.

The diffraction grating 310 may be configured to reflect and diffract light to travel with a wavelength or a wave range in the light guide plate 301.

The optical properties (specifically diffraction properties) of the diffraction gratings 330, 320, and 310 are adjusted thus, thereby controlling light traveling in the light guide plates.

The light guide plate 301 causes light reflected diffracted by the diffraction grating 310 to travel to the diffraction grating 311 while totally reflecting the light.

The light guide plate 302 causes light reflected diffracted by the diffraction grating 320 to travel to the diffraction grating 321 while totally reflecting the light.

The light guide plate 303 causes light reflected diffracted by the diffraction grating 330 to travel to the diffraction grating 331 while totally reflecting the light.

The diffraction grating 311 may be configured to reflect and diffract light that has traveled in the light guide plate 301 and reached the diffraction grating 311.

The diffraction grating 321 may be configured to transmit light that has been reflected and diffracted by the diffraction grating 311 and emitted out of the light guide plate 301 and reflect and diffract light that has traveled in the light guide plate 302 and reached the diffraction grating 321.

The diffraction grating 331 may be configured to transmit light that has been transmitted through the diffraction grating 321 and emitted out of the light guide plate 302 and light that has been reflected and diffracted by the diffraction grating 321 and emitted out of the light guide plate 302 and reflect and diffract light that has traveled in the light guide plate 303 and reached the diffraction grating 331.

The optical properties (specifically diffraction properties) of the diffraction gratings 311, 321, and 331 are adjusted thus, so that the light beams having traveled in the light guide plates are multiplexed and projected to the eyes of a user.

In an embodiment, light traveling in the light guide plates may be divided according to wavelengths or wave ranges. Specifically, the diffraction gratings may be configured to reflect and diffract light with a predetermined wavelength or wave range and/or transmit light with another predetermined wavelength or wave range.

In another embodiment, light traveling in the light guide plates may partially form an angle of view of video to be presented to a user. Specifically, video display light to be presented to the user may have divided angles of view in the light guide plate and travel in the light guide plate laminate (specifically in the light guide plates), and video display light beams having traveled in the light guide plates may collectively form the overall angle of view when being emitted out of the light guide plate laminate.

### (6) Modification Example (Layout of Pressure-Reducing Space)

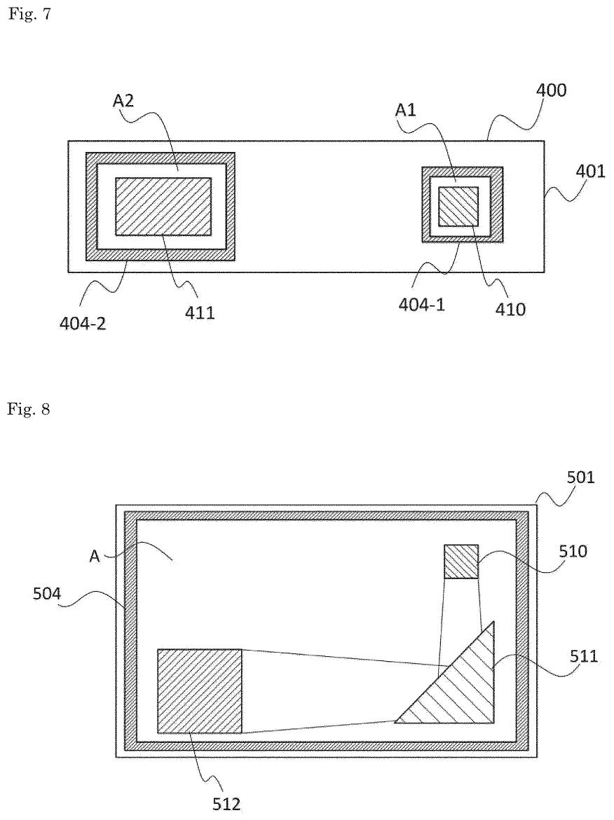

In the configuration example described in (1), the space between the two light guide plates forming a pair of light guide plates is placed in a state of reduced pressure. In other words, a single pressure-reducing region is present. As illustrated in the top view, the single pressure-reducing region includes both of the diffraction grating that causes video display light to travel in the light guide plate and the diffraction grating that emits video display light from the light guide plate. In an embodiment of the present disclosure, two or more spaces may be present in a state of reduced pressure between two light guide plates forming a pair of light guide plates. In other words, two or more pressure-reducing regions may be present between the two light guide plates. Each of the pressure-reducing regions may include the diffraction grating that causes video display light to travel in the light guide plate and the diffraction grating that emits video display light from the light guide plate. Referring to FIG. 7, the embodiment will be described below.

FIG. 7 is a top view illustrating an example of a light guide plate laminate according to the embodiment. A light guide plate laminate 400 illustrated in the drawing includes a pair of light guide plates with a pressure-reducing region interposed therebetween. FIG. 7 is a top view and thus shows a light guide plate 401 as one of the light guide plates.

The light guide plate 401 includes diffraction gratings 410 and 411.

The diffraction gratings 410 and 411 have the same optical properties (specifically diffraction properties) as the diffraction gratings 110 and 111 described in (1).

As illustrated in the top view of FIG. 7, the diffraction grating 410 is provided in a region A1 defined by an adhesive 404-1. In other words, the adhesive 404-1 is provided around the diffraction grating that passes video display light into the light guide plate.

The diffraction grating 411 is provided in a region A2 defined by an adhesive 404-2. In other words, the adhesive 404-2 is provided around the diffraction grating that emits video display light from the inside of the light guide plate.

The other light guide plate also includes two diffraction gratings like the diffraction gratings 120 and 121 described in (1). These diffraction gratings are surrounded by the adhesives 404-1 and 404-2 like the diffraction gratings 410 and 411.

As described above, an entrance portion and an exit portion are respectively covered with two spaces in a state of reduced pressure.

As described above, the diffraction gratings for emitting video display light into and out of the light guide plate are present in a pressure-reducing space (in a region surrounded by the adhesive that defines the pressure-reducing space), which contributes to improvement in image quality. This can achieve, for example, an improvement in resolution or prevention of a color shift. Moreover, the pressure-reducing region is formed around a region where the diffraction grating is formed, thereby efficiently keeping a uniform gap. For example, the amount of adhesive usage can be reduced.

### (7) Modification Example (Layout of Diffraction Grating)

In the configuration example described in (1), each of the light guide plates is provided with the two diffraction gratings. In an embodiment of the present disclosure, three or more diffraction gratings may be provided in a light guide plate. The number of diffraction gratings provided in the light guide plate may be, for example, five or less or four or less. Referring to FIG. 8, the embodiment will be described below.

FIG. 8 illustrates a layout example of diffraction gratings on a light guide plate. A light guide plate 501 in FIG. 8 is provided with diffraction gratings 510, 511, and 512. The diffraction gratings 510, 511, and 512 are present in a region A surrounded by an adhesive 504.

The diffraction grating 510 is configured to reflect and diffract video display light traveling in the light guide plate 501 and cause the video display light to travel in the light guide plate. The diffraction grating 510 diffracts the video display light to cause the video display light to travel to the diffraction grating 511. The diffraction grating 510 diffracts the video display light to expand the video display light.

The diffraction grating 511 diffracts the video display light reaching the diffraction grating 511 to cause the video display light to travel to the diffraction grating 512. Moreover, the diffraction grating 511 diffracts the video display light to expand the video display light. The diffraction grating 511 is also called a folded (bent) diffraction grating.

The diffraction grating 512 reflects and diffracts the video display light reaching the diffraction grating 512 such that the video display light is emitted from the light guide plate 501.

The diffraction gratings 510, 511, and 512 in the drawing are disposed to form an angle of about 90° on the light guide plate. The angle is not limited to 90° and may be changed as appropriate.

A light guide plate laminate according to the present disclosure may include a plurality of light guide plates, each including three diffraction gratings. A space between the light guide plates may be placed in a state of reduced pressure.

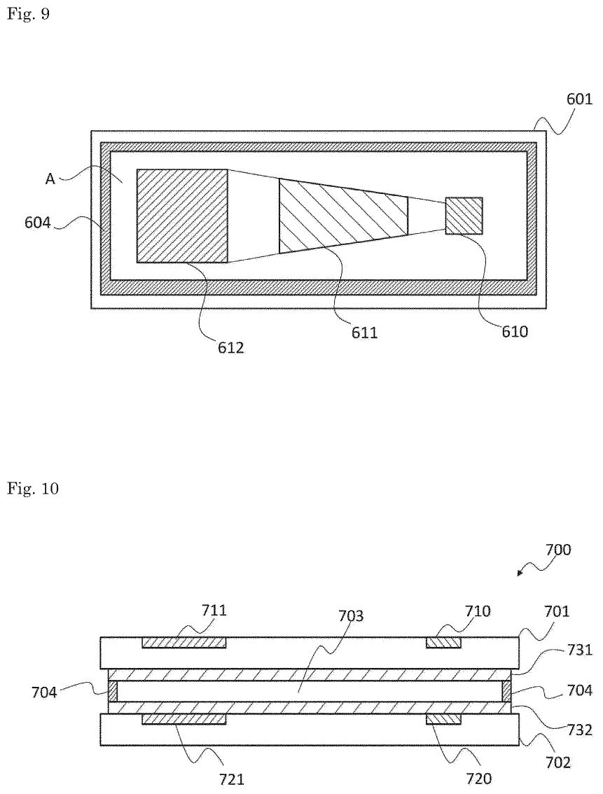

The light guide plate 501 further includes the folded diffraction grating. In other words, the traveling direction of video display light is changed in the light guide plate. In the present disclosure, an expander diffraction grating may be adopted instead of the folded diffraction grating. The expander diffraction grating is a diffraction grating that expands video display light. FIG. 9 illustrates a configuration example of a light guide plate including the expander diffraction grating.

FIG. 9 illustrates a layout example of diffraction gratings on the light guide plate. A light guide plate 601 in FIG. 9 is provided with diffraction gratings 610, 611, and 612. The diffraction gratings 610, 611, and 612 are present in a region A surrounded by an adhesive 604.

The diffraction grating 610 is configured to reflect and diffract video display light traveling in the light guide plate 601 and cause the video display light to travel in the light guide plate. The diffraction grating 610 diffracts the video display light to cause the video display light to travel to the diffraction grating 611. The diffraction grating 610 diffracts the video display light to expand the video display light.

The diffraction grating 611 diffracts the video display light reaching the diffraction grating 611 to cause the video display light to travel to the diffraction grating 612. Moreover, the diffraction grating 611 diffracts the video display light to expand the video display light. The diffraction grating 611 is also called an expander (expanding) diffraction grating.

The diffraction grating 612 reflects and diffracts the video display light reaching the diffraction grating 612 such that the video display light is emitted from the light guide plate 601.

The diffraction gratings 610, 611, and 612 in the drawing are linearly disposed on the light guide plate.

A light guide plate laminate according to the present disclosure may include a plurality of light guide plates, each including three diffraction gratings.

In an HMD, the position of incidence of video display light to the light guide plate and the position of emission of video display light from the light guide plate cannot be freely selected depending upon, for example, the structure of the device, which may limit a region where these positions can be located. Furthermore, the size of the light guide plate may be limited and thus only the provision of the two diffraction gratings on each of the light guide plates may fail to sufficiently expand video display light. In this case, the provision of three or more diffraction gratings on the light guide plate can present proper video display light to a user even if such a restriction is imposed.

### (8) Modification Example (Gas Barrier Layer)

A light guide plate laminate according to the present disclosure may include one or more gas barrier layers stacked on each of the light guide plates. The one or more gas barrier layers may be stacked on the respective light guide plates. The one or more gas barrier layers may be joined to an adhesive. The space in a state of reduced pressure may be formed by the adhesive and the one or more gas barrier layers. The state of reduced pressure in the space can be more securely kept by the one or more gas barrier layers. Referring to FIG. 10, an example of the light guide plate laminate including the gas barrier layers according to the present disclosure will be described below.

A light guide plate laminate 700 illustrated in the drawing includes a pair of light guide plates 701 and 702.

A gas barrier layer 731 is stacked on the light guide plate 701.

A gas barrier layer 732 is stacked on the light guide plate 702.

The light guide plates 701 and 702 are stacked with a space 703 provided therebetween. More specifically, the space 703 is present between the gas barrier layers 731 and 732. The space is in a state of reduced pressure. In order to form the space, the gas barrier layers 731 and 732 are bonded with an adhesive 704 including a spacer. In other words, the space 703 is enclosed with the adhesive 104 and the gas barrier layers 731 and 732. As described above, the space between the stacked light guide plates in the pair is in a state of reduced pressure, thereby keeping a uniform gap between the two light guide plates.

The light guide plate 701 includes diffraction gratings 710 and 711.

The diffraction gratings 710 and 711 have the same optical properties (specifically diffraction properties) as the diffraction gratings 110 and 111 described in (1).

The light guide plate 702 includes diffraction gratings 720 and 721.

The diffraction gratings 720 and 721 have the same optical properties (specifically diffraction properties) as the diffraction gratings 120 and 121 described in (1).

The gas barrier layer may have a moisture-vapor transmission of, for example, 0.1 g/m²/day or less, preferably 0.01 g/m²/day or less, or more preferably 0.001 g/m²/day or less.

The gas barrier layer may have a moisture-vapor transmission of, for example, 0.000001 g/m²/day or more or 0.00001 g/m²/day or more.

The moisture-vapor transmission is measured by a moisture-vapor transmission measuring device PERMATRAN-W3/34G.

The air component transmission of the gas barrier layer may be represented as a transmission of a principal component contained in air and may be, for example, an oxygen transmission or a nitrogen transmission.

The gas barrier layer may have a nitrogen transmission of, for example, 0.1 cc/m²/day or less, preferably 0.01 cc/m²/day or less, or more preferably 0.001 cc/m²/day or less.

The gas barrier layer may have a nitrogen transmission of, for example, 0.000001 cc/m²/day or more or 0.00001 cc/m²/day or more.

The nitrogen transmission may be measured according to, for example, JIS K 7126-1.

The gas barrier layer may have an oxygen transmission of, for example, 0.1 cc/m²/day or less, preferably 0.01 cc/m²/day or less, or more preferably 0.001 cc/m²/day or less.

The gas barrier layer may have an oxygen transmission of, for example, 0.000001 cc/m²/day or more or 0.00001 cc/m²/day or more.

The oxygen transmission is measured by an oxygen transmission measuring device OX-TRAN2/22L.

In the present disclosure, each laminate including a gas barrier layer and a light guide plate may have the foregoing water-vapor transmission. Alternatively, each light guide plate may have the water-vapor transmission. In the present disclosure, each laminate including a gas barrier layer and a light guide plate may have the oxygen transmission. Alternatively, each light guide plate may have the oxygen transmission.

The gas barrier layer may include, for example, an inorganic layer or have the inorganic layer alone. The inorganic layer may contain, for example, silicon oxide, silicon oxynitride, aluminum oxide, magnesium oxide, titanium oxide, tin oxide, an indium oxide alloy, silicon nitride, aluminum nitride, or titanium nitride as a principal component. The inorganic layer may be a metallic film, for example, an aluminum film, a silver film, a tin film, a chromium film, a nickel film, or a titanium film.

The gas barrier layer may be stacked on the light guide plate in step S11, S12, S13, S21, S22, or S23 described in (2) and (4). The layer may be stacked according to physical vapor deposition, for example, vacuum deposition, oxidation reaction deposition, sputtering, or ion plating. Alternatively, the layer may be stacked according to plasma chemical vapor deposition.

### (9) Modification Example (Example of Transmission Diffraction)

The diffraction grating included in the light guide plate laminate described in (1) is configured to cause video display light to travel in the light guide plate through reflection and diffraction. In the present disclosure, the kind of diffraction is not limited to reflection and diffraction. As the diffraction grating, for example, a diffraction grating for transmission and diffraction may be adopted. Referring to FIG. 12, an example of the light guide plate laminate using the diffraction grating for transmission diffraction will be described below.

FIG. 12 illustrates a configuration example of the light guide plate laminate according to the present disclosure. A light guide plate laminate 900 illustrated in the drawing includes a pair of light guide plates 901 and 902. The light guide plates 901 and 902 are stacked with a space 903 provided therebetween. The space is in a state of reduced pressure. In order to form the space, the light guide plates 901 and 902 are bonded with an adhesive 904 including a spacer. The light guide plates 901 and 902, the space 903, and the adhesive 904 may be identical to the light guide plates 101 and 102, the space 103, and the adhesive 104 that are described in (1). The description thereof also applies to the present example.

The light guide plate 901 includes diffraction gratings 910 and 911. The light guide plate 902 includes diffraction gratings 920 and 921. From among these diffraction gratings, the diffraction gratings 910 and 920 are included in an entrance portion 950. The diffraction gratings 911 and 921 are included in an exit portion 951.

The diffraction grating 910 may be provided at a position where video display light enters the light guide plate 901. The diffraction grating 910 may be configured to transmit and diffract video display light reaching the diffraction grating 910 and cause the video display light to travel in the light guide plate 901. The video display light travels to the diffraction grating 911 while totally reflecting in the light guide plate 901.

The diffraction grating 911 may be provided at a position where video display light is emitted from the light guide plate 901. The diffraction grating 911 may be configured to diffract video display light reaching the diffraction grating 911 and cause the video display light to travel out of the light guide plate 901.

The diffraction grating 920 may be provided at a position where video display light enters the light guide plate 902. The diffraction grating 920 may be configured to transmit and diffract video display light reaching the diffraction grating 920 and cause the video display light to travel out of the light guide plate 902.

The diffraction grating 921 may be provided at a position where video display light is emitted from the light guide plate 902. The diffraction grating 921 may be configured to transmit and diffract video display light reaching the diffraction grating 921 and cause the video display light to travel out of the light guide plate 902.

As described above, a diffraction grating for transmission and diffraction may be adopted as the diffraction grating included in the light guide plate laminate.

### 3. Second Embodiment (Display Device)

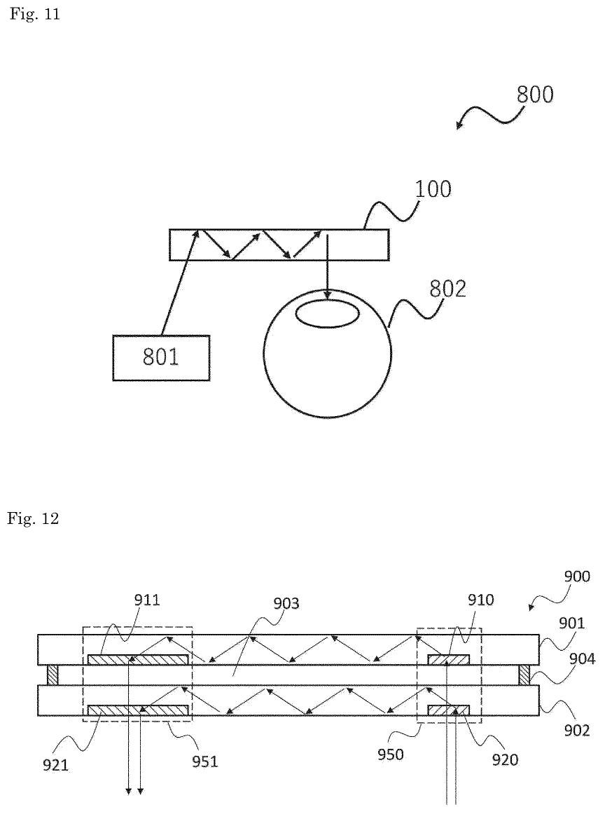

The present disclosure also provides a display device including the light guide plate laminate described in 2. Referring to FIG. 11, an example of the display device will be described below.

A display device 800 illustrated in the drawing includes a rendering system 801 and the light guide plate laminate 100.

The rendering system 801 forms video display light to be guided by the light guide plate laminate 100. The light guide plate laminate 100 guides the video display light and causes the video display light to reach a user's eye 802. The light guide plate laminate 100 may be configured as described in (1) of 2. The display device 800 may include another light guide plate laminate according to the present disclosure instead of the light guide plate laminate 100.

The display device 800 may include one or more optical elements, which are not illustrated, on an optical path between the rendering system 801 and the light guide plate laminate 100. The optical element may include a light guide optical system. The light guide optical system may include, for example, one or more collimator lenses and/or one or more relay lenses.

The rendering system 801 may be stored in a housing. The light guide optical system may also be stored in the housing.

The display device 800 may further include an instrument for holding the light guide plate laminate 100 in front of the eye. The instrument may include, for example, a temple portion and a rim portion of glasses. The housing may be attached to the instrument.

The display device 800 may be configured as, for example, a head-mounted display (hereinafter also referred to as an HMD). The head-mounted display may be, for example, a see-through HMD or a non-see-through HMD.

The see-through HMD may be configured as, for example, a glass-like display. In this case, the light guide plate laminate 100 may transmit light from an external scene and cause the light to reach an eye. The light guide plate laminate 100 may be provided on a portion corresponding to a spectacle lens. Video presented by the display device 800 can be superimposed on an external scene by the see-through HMD. For example, AR can be provided to a user.

For example, the non-see-through HMD may completely cover both eyes. In this case, light from an external scene does not reach the eyes.

### 4. Third Embodiment (Module for Display Device)

The present disclosure also provides a module for a display device including the light guide plate laminate described in 2. The module for the display device may include the light guide plate laminate according to the present disclosure and any one of constituent elements included in the display device described in 3. For example, the module for the display device may include the light guide plate laminate and the rendering system. Alternatively, the module for the display device may include the light guide plate laminate and the instrument provided with the light guide plate laminate.

The present disclosure may be configured as follows:

[1]
at least a pair of light guide plates, the two light guide plates being stacked,
wherein a space between the two light guide plates is in a state of reduced pressure.
   [2]

The light guide plate laminate according to [1], wherein the space has a pressure of 90 kPa or less.

[3]

The light guide plate laminate according to [1] or [2], wherein the space is enclosed.

[4]

The light guide plate laminate according to any one of [1] to [3], wherein the two light guide plates are stacked with an adhesive interposed between the light guide plates.

[5]

The light guide plate laminate according to [4], wherein the adhesive includes a spacer.

[6]

The light guide plate laminate according to any one of [1] to [5], wherein the light guide plate laminate includes one or more gas barrier layers stacked on each of the light guide plates.

[7]

The light guide plate laminate according to [6], wherein the one or more gas barrier layers are joined to an adhesive, and the space is formed by the one or more gas barrier layers and the adhesive.

[8]

The light guide plate laminate according to any one of [1] to [7], wherein the light guide plate laminate includes an entrance portion that passes light into each of the light guide plates and an exit portion that emits light from each of the light guide plates.

[9]

The light guide plate laminate according to [8], wherein the space in the state of reduced pressure covers one or both of the entrance portion and the exit portion.

[10]

The light guide plate laminate according to [8] or [9], wherein the entrance portion, the exit portion, or both of the entrance portion and the exit portion include diffraction gratings provided on each of the light guide plates.

[11]

The light guide plate laminate according to any one of [1] to [10], wherein the light guide plate laminate includes a pressure-reducing port sealed with a sealer.

[12]

The light guide plate laminate according to any one of [1] to [11], wherein the light guide plate laminate may include three or more stacked light guide plates, and a space between two of the three or more light guide plates is placed in a state of reduced pressure.

[13]

The light guide plate laminate according to any one of [1] to [12], wherein the light guide plate laminate includes a pressure-reducing region between the two light guide plates.

[14]

The light guide plate laminate according to any one of [1] to [12], wherein the light guide plate laminate includes two or more pressure-reducing regions between the two light guide plates.

[15]

The light guide plate laminate according to any one of [1] to [14], wherein each of the light guide plates included in the light guide plate laminate is provided with two diffraction gratings.

[16]

The light guide plate laminate according to any one of [1] to [14], wherein each of the light guide plates included in the light guide plate laminate is provided with three or more diffraction gratings.

[17]

A display device including a light guide plate laminate including at least a pair of light guide plates, the two light guide plates being stacked,
wherein a space between the two light guide plates is in a state of reduced pressure.
   [18]

A module for a display device including a light guide plate laminate including at least a pair of light guide plates, the two light guide plates being stacked,
wherein a space between the two light guide plates is in a state of reduced pressure.

Although embodiments and examples of the present disclosure have been described above in detail, the present disclosure is not limited to the above-described embodiments and examples and various modifications based on the technical spirit of the present disclosure can be made.

For example, the configurations, the methods, the processes, the shapes, the materials, the numerical values, and the like exemplified in the embodiments and the examples described above are only examples, and as necessary, different configurations, methods, processes, shapes, materials, numerical values, and the like may be used. Furthermore, the configurations, methods, steps, shapes, materials, and numerical values or the like of the embodiments and the examples described above can be combined without departing from the gist of the present disclosure.

In the present specification, a numerical range represented using “to” represents a range including numerical values represented before and after “to” as a minimum value and a maximum value. In the numerical ranges described in a stepwise manner in the present specification, an upper limit value or a lower limit value of a numerical range in any step may be replaced with an upper limit value or a lower limit value of a numerical range in another step.

### REFERENCE SIGNS LIST

100 Light guide plate laminate
101, 102 Light guide plate
103 Space

What is claimed is:

1. A light guide plate laminate comprising at least a pair of light guide plates, the two light guide plates being stacked,
wherein a space between the two light guide plates is in a state of reduced pressure.

2. The light guide plate laminate according to claim 1, wherein the space has a pressure of 90 kPa or less.

3. The light guide plate laminate according to claim 1, wherein the space is enclosed.

4. The light guide plate laminate according to claim 1, wherein the two light guide plates are stacked with an adhesive interposed between the light guide plates.

5. The light guide plate laminate according to claim 4, wherein the adhesive includes a spacer.

6. The light guide plate laminate according to claim 1, wherein the light guide plate laminate includes one or more gas barrier layers stacked on each of the light guide plates.

7. The light guide plate laminate according to claim 6, wherein the one or more gas barrier layers are joined to an adhesive, and the space is formed by the one or more gas barrier layers and the adhesive.

8. The light guide plate laminate according to claim 1, wherein the light guide plate laminate includes an entrance portion that passes light into each of the light guide plates and an exit portion that emits light from each of the light guide plates.

9. The light guide plate laminate according to claim 8, wherein the space in the state of reduced pressure covers one or both of the entrance portion and the exit portion.

10. The light guide plate laminate according to claim 8, wherein the entrance portion, the exit portion, or both of the entrance portion and the exit portion include diffraction gratings provided on each of the light guide plates.

11. The light guide plate laminate according to claim 1, wherein the light guide plate laminate includes a pressure-reducing port sealed with a sealer.

12. The light guide plate laminate according to claim 1, wherein the light guide plate laminate includes three or more stacked light guide plates, and
a space between two of the three or more light guide plates is placed in a state of reduced pressure.

13. The light guide plate laminate according to claim 1, wherein the light guide plate laminate includes a pressure-reducing region between the two light guide plates.

14. The light guide plate laminate according to claim 1, wherein the light guide plate laminate includes two or more pressure-reducing regions between the two light guide plates.

15. The light guide plate laminate according to claim 1, wherein each of the light guide plates included in the light guide plate laminate is provided with two diffraction gratings.

16. The light guide plate laminate according to claim 1, wherein each of the light guide plates included in the light guide plate laminate is provided with three or more diffraction gratings.

17. A display device comprising a light guide plate laminate including at least a pair of light guide plates, the two light guide plates being stacked,
wherein a space between the two light guide plates is in a state of reduced pressure.

18. A module for a display device comprising a light guide plate laminate including at least a pair of light guide plates, the two light guide plates being stacked,
wherein a space between the two light guide plates is in a state of reduced pressure.
